(19) United States
(12) Patent Application Publication
(10) Pub. No.: US 2026/0085174 A1
(43) Pub. Date: Mar. 26, 2026

(54) MICRONIZED POLYMER PELLETS WITH ANTISTATIC PROPERTIES AND A PROCESS AND SYSTEM FOR PREPARING SAME

(71) Applicants: PolyChem Alloy, Inc., Lenoir, NC (US); Sanyo Chemical America, Inc., Charleroi, PA (US)

(72) Inventors: Chakra V. GUPTA, Lenoir, NC (US); Ashton Ray BARLOW, Lenoir, NC (US); Ryusuke WATANABE, Pittsburgh, PA (US)

(73) Assignees: PolyChem Alloy, Inc., Lenior, NC (US); Sanyo Chemical America, Inc., Charleroi, PA (US)

(21) Appl. No.: 19/312,627

(22) Filed: Aug. 28, 2025

Related U.S. Application Data
(60) Provisional application No. 63/697,822, filed on Sep. 23, 2024.
(60) Provisional application No. 63/868,720, filed on Aug. 22, 2025.

(51) Int. Cl. C08L 23/06; B29B 9/06; B29K 23/00; B29K 25/00; B29K 105/00; C08K 5/00

(52) U.S. Cl. CPC C08L 23/06; B29B 9/06; C08K 5/0075; B29K 2023/0625; B29K 2023/065; B29K 2025/08; B29K 2105/0008; B29K 2105/0088; C08L 2201/04; C08L 2205/025; C08L 2205/035; C08L 2207/062; C08L 2207/066

(57) ABSTRACT

A system and method for preparing micronized polymer pellets is provided. The micronized polymer pellets include a polymer resin and an antistat agent. The micronized polymer pellets are particularly useful for rotomolding applications.

### CROSS-REFERENCE TO RELATED APPLICATION

The present application claims priority of U.S. Provisional Application No. 63/697,822, filed Sep. 23, 2024 and U.S. Provisional Application No. 63/866,720, filed Aug. 22, 2025, the contents of which are hereby incorporated by reference.

### FIELD

The disclosure relates to a process and system for the preparation of micronized polymer pellets for use in molding applications, and in particular, micronized polymer pellets having antistatic properties.

### BACKGROUND

Rotational molding, also known as rotomolding, is a mold process in which a powder polymer material is loaded into a mold. The mold is heated while simultaneously being biaxially rotated. As the heated mold is rotated, the polymer material melts and adheres to the walls of the mold and coalesces to define a s structure having a hollow interior space.

Rotomolding can be used to prepare a wide variety of articles including storage tanks, such a water tanks, furniture, road signs and bollards, planters, pet houses, toys, bins and refuse containers, doll parts, road cones, footballs, helmets, canoes, rowing boats, and the like.

An important aspect of rotomolding is the need for consistent distribution and melting of the polymer material. Failure of the polymer material to not fully melt or to not be evenly distributed to the surface of the mold, may results in defects in the molded article. Such defects may include the formation of voids, bubbles, uneven surface, reduction in mechanical properties, and also in the molded article being aesthetically unappealing.

To help ensure uniform melting and distribution of the polymer material in the mold, the polymer material is typically ground into a fine powder. The use of pulverized powders has several drawbacks. First, the pulverization process can result in a mix of fine particles having a wide particle size distribution, which can result in uneven melting and distribution of the polymer material. This may result in the formation of the aforementioned defects in the molded article. Second, the use of pulverized powders tends to create dust in which a portion of the particles are aerosolized. This can result in dangerous conditions from an environmental and health standpoint.

Accordingly, there still exists a need to provide improved polymer materials for use in rotomolding applications.

### SUMMARY

One or more embodiments of the disclosure may help to provide a solution to the aforementioned problems. In certain embodiments, the disclosure provides a polymeric mass comprising a plurality of micronized polymer pellets. The micronized polymer pellets have an average particle size of less than 800 microns with a relatively narrow particle size distribution. Advantageously, the micronized polymer pellets exhibit good flow properties indicating that they are particularly useful in rotomolding applications.

In certain embodiments, the micronized polymer pellets exhibit antistatic properties. In addition, articles prepared from the micronized polymer pellets in accordance with certain embodiments of the disclosure also are characterized by successfully meeting and exceeding the criteria of test method Environmental Stress Cracking Resistance (ESCR) following 500 hours of observation, and in particular, following 2,000 hours of observation.

In certain embodiments, the disclosure is directed to a bulk polymer composition comprising a plurality of micronized polymer pellets comprising a blend of a polymer resin and an antistatic agent, and in which the plurality of polymer particles have an average particle size of less than 800 microns (μm), and the polymer composition exhibits a surface resistivity of less than 1×10¹³Ω.

In some embodiments, the polymer resin is selected from the group consisting of polyolefins, nylons, polycarbonates, and polyesters. For example, the polymer may comprise a polyolefin or a blend of polyolefins. Specific examples include polyethylene, polypropylene, and blends thereof.

In certain embodiments, the polymer resin comprises a polyolefin is selected from the group consisting of linear low density polyethylene (LLDPE), low density polyethylene (LDPE), mid density polyethylene (MDPE) and high density polyethylene (HDPE), and blends thereof.

In certain embodiments, the polymer resin comprises a polymer blend comprising LLDPE and HDPE. The amount of LLDPE in the blend may be from about 5 to 95 weight percent and the amount of HDPE in the blend may be from about 5 to 95 weight percent, based on the total weight of the polymer composition.

In some embodiments, the polymer resin may also include ethylene vinyl acetate.

In some embodiments, the polymer resin may also include a styrene-ethylene-butylene-styrene block copolymer.

In certain embodiments, the antistat agent comprises a copolymer of a hydrophobic polymer and a hydrophilic polymer, an ionic liquid, and a salt.

In certain embodiments, the amount of antistat agent in the polymer composition is from about 5 to 35 weight percent, and in particular, from about 10 to 20 weight percent, based on the total weight of the composition.

In certain embodiments, the polymer composition may further comprise one or more of an antioxidant, a styrene containing elastomer, and a UV stabilizer.

In certain embodiments, the polymer composition comprises from about 70 to 85 weight percent of a polyolefin resin (e.g., polyethylene); from about 5 to 20 weight precent of the antistat agent, and from about 5 to 15 weight percent of a polyolefin elastomer, based on the total weight of the polymer composition.

In certain embodiments, the polymer resin comprises a high density polyethylene, the antistat agent comprises a copolymer of a hydrophobic polymer and a hydrophilic polymer, an ionic liquid, and a salt, and the polyolefin elastomer comprises a propylene based alpha-olefin copolymer.

In some embodiments, the polymer resin is a polyolefin resin comprising high density polyethylene that is present in an amount from about 75 to 80 weight percent, the antistat agent is present in an amount from about 12 to 18 weight percent, and the polyolefin elastomer (e.g., a propylene based alpha-olefin copolymer) is present in an amount from about 6 to 10 weight percent, based on the total weight of the polymer composition.

In certain embodiments, the plurality of micronized polymer pellets exhibit an average particle size of less than 500 μm with a standard deviation of less than 50 μm.

In some embodiments, the plurality of micronized polymer pellets are characterized by exhibiting an average particle size ranging from 400 to 500 μm with a standard deviation of less than 50 μm and a surface resistivity ranging from about 1×10⁵ to 1×10¹²Ω.

In certain embodiments, the plurality of micronized polymer pellets are characterized by exhibiting a Falling Time ranging from about 10 to 15 seconds and an Angle of Repose ranging from about 30 to 38 degrees.

In certain embodiments, the plurality of micronized polymer pellets are characterized by the following:
a) an average particle size ranging from 200 to 500 μm with a standard deviation of less than 50 μm;
b) a surface resistivity ranging from about 1×10⁵ to 1×10¹²Ω;
c) a Falling time ranging from about 10 to 15 seconds; and
d) an Angle of Repose ranging from about 30 to 38 degrees.

In certain embodiments, the plurality of micronized polymer pellets are characterized by the following:
a) an average particle size of about 200 to 500 μm (for example, 450 μm) with a standard deviation of less than 25 μm;
b) a surface resistivity ranging from about 1×10⁹ to 1×10¹⁰Ω;
c) a Falling time ranging from about 10 to 12 seconds; and
d) an Angle of Repose ranging from about 30 to 38 degrees.

In certain embodiments, a rotomolded article prepared from the plurality of micronized polymer pellets according to the disclosure exhibits an environmental stress crack resistance (ESCR) of at least 500 hours without the observance of cracks or other defects.

In certain embodiments, a rotomolded article prepared from the plurality of micronized polymer pellets exhibits an environmental stress crack resistance (ESCR) of at least 1,000 hours, without the observance of cracks or other defects.

In certain embodiments, a rotomolded article prepared from the plurality of micronized polymer pellets exhibits an environmental stress crack resistance (ESCR) of at least 2,000 hours, without the observance of cracks or other defects.

In certain embodiments, a rotomolded article exhibits a surface resistivity ranging from about 1×10⁵ to 1×10¹²Ω.

In additional aspect of the disclosure, a method of preparing micronized polymer pellets is provided.

In certain embodiments, the method of preparing micronized polymer pellets comprises
mixing a polymer resin and an antistat agent to form a homogeneous polymer mixture;
introducing the polymer mixture into an extruder;
melting and kneading the polymer mixture in the extruder to form a molten or semi-molten polymer stream;
introducing the polymer stream into a melt pump;
measuring the pressure of the polymer stream exiting the melt pump;
adjusting the pressure of the polymer stream as it exits the melt pump to a predetermined pressure threshold for the polymer stream;
introducing the polymer stream into a pellet die, said pellet die comprising a plurality of fluid channels and corresponding extrusion orifices, the extrusion orifices having diameters ranging from about 0.20 to 0.50 mm;
dividing the polymer stream to flow through the plurality of fluid channels to form a plurality of polymer strands;
extruding the plurality of polymer strands through said extrusion orifices,
cutting the plurality of polymer strands to form a plurality of micronized polymer pellets; and
drying and collecting the micronized polymer pellets.

In certain embodiments, the plurality of micronized polymer pellets prepared in accordance with the method may be characterized by the following:
b) an average particle size ranging from 200 to 500 μm with a standard deviation of less than 50 μm;
b) a surface resistivity ranging from about 1×10⁵ to 1×10¹²Ω;
c) a Falling time ranging from about 10 to 15 seconds; and
d) an Angle of Repose ranging from about 30 to 38 degrees.

In certain embodiments of the method, the step of adjusting the pressure of the polymer stream comprises measuring a pressure of the polymer stream prior to introducing the polymer stream into the melt pump and then adjusting an operational speed of the melt pump and/or the extruder to increase the pressure of the polymer stream to the predetermined pressure threshold

In certain embodiments of the method, the predetermined pressure threshold is stored in a computer (e.g., a PLC) having a memory storage device comprising executable program code, the executable program code being configured to instruct the melt pump to adjust the operational speed of the melt pump to achieve the predetermined pressure threshold for the polymer stream.

In certain embodiments of the method, the step of cutting the plurality of polymer strands to form a plurality of micronized polymer pellets is performed within a water bath, the water bath comprising a stream of heated water that is heated to a temperature ranging from about 70 to 90° C., such as from about 78 to 86° C.

In certain embodiments of the method, the stream of heated water collects the plurality of micronized polymer pellets and carries the plurality of micronized polymer pellets to a dryer unit, such as a centrifugal dryer.

In certain embodiments of the method, the polymer resin is selected from the group consisting of polyolefins, nylons, polycarbonates, and polyesters, and blends thereof.

In certain embodiments of the method, the polymer resin comprises a polyolefin, such as polyethylene, polypropylene, and blends thereof.

In certain embodiments of the method, the polyolefin is selected from the group consisting of linear low density polyethylene (LLDPE), low density polyethylene (LDPE), (mid density polyethylene (MDPE) and high density polyethylene (HDPE), and blends thereof.

In certain embodiments of the method, the polymer resin comprises a blend of a LLDPE and a HDPE. In some embodiments, the amount of LLDPE in the blend is from about 5 to 95 weight percent and the amount of HDPE in the blend is from about 5 to 95 weight percent, based on the total weight of the polymer composition.

In certain embodiments of the method, the polymer resin further comprising ethylene vinyl acetate. In some embodiments, the polymer resin may also include a polymeric elastomer. Examples of polyolefinic elastomers include propylene/α-olefin copolymers, styrene-ethylene-butylene-styrene block copolymers, and blends thereof.

The amount of the polymeric elastomer in the polymer composition may range from about 4 to 12 weight percent, and in particular, from about 6 to 10 weight percent, and more particularly, from about 7 to 9 weight percent, based on the total weight of the polymer composition.

In certain embodiments of the method, the antistat agent comprises a copolymer of a hydrophobic polymer and a hydrophilic polymer, an ionic liquid, and a salt. In some embodiments, the amount of antistat agent in the polymer mixture is from about 5 to 35 weight percent, and in particular, from about 10 to 20 weight percent, based on the total weight of the mixture.

In certain embodiments of the method, the polymer mixture may include one or more of an antioxidant, a styrene containing elastomer, and a UV stabilizer.

In certain embodiments of the method, the polymer composition comprises from about 70 to 85 weight percent of a polyolefin resin (e.g., polyethylene); from about 5 to 20 weight precent of the antistat agent, and from about 5 to 15 weight percent of a polyolefin elastomer, based on the total weight of the polymer composition.

In certain embodiments of the method, the polymer resin comprises a high density polyethylene, the antistat agent comprises a copolymer of a hydrophobic polymer and a hydrophilic polymer, an ionic liquid, and a salt, and the polyolefin elastomer comprises a propylene based alpha-olefin copolymer.

In some embodiments, the polymer resin is a polyolefin resin comprising high density polyethylene that is present in an amount from about 75 to 80 weight percent, the antistat agent is present in an amount from about 12 to 18 weight percent, and the polyolefin elastomer (e.g., a propylene based alpha-olefin copolymer) is present in an amount from about 6 to 10 weight percent, based on the total weight of the polymer composition.

In certain embodiments of the method, the plurality of micronized polymer pellets exhibit an average particle size of less than 500 μm with a standard deviation of less than 50 μm.

In some embodiments of the method, the plurality of micronized polymer pellets are characterized by exhibiting an average particle size ranging from 400 to 500 μm with a standard deviation of less than 50 μm and a surface resistivity ranging from about 1×10⁵ to 1×10¹²Ω.

In certain embodiments of the method, the plurality of micronized polymer pellets are characterized by exhibiting a Falling Time ranging from about 10 to 15 seconds and an Angle of Repose ranging from about 30 to 38 degrees.

In certain embodiments of the method, the plurality of micronized polymer pellets are characterized by the following:
a) an average particle size ranging from 400 to 500 μm with a standard deviation of less than 50 μm;
b) a surface resistivity ranging from about 1×10⁵ to 1×10¹²Ω;
c) a Falling time ranging from about 10 to 15 seconds; and
d) an Angle of Repose ranging from about 30 to 38 degrees.

In certain embodiments of the method, the plurality of micronized polymer pellets are characterized by the following:
a) an average particle size of about 450 μm with a standard deviation of less than 25 μm;
b) a surface resistivity ranging from about 1×10⁹ to 1×10100;
c) a Falling time ranging from about 10 to 12 seconds; and
d) an Angle of Repose ranging from about 30 to 38 degrees.

In certain embodiments of the method, the method comprises a step of rotomolding an article comprising the plurality of micronized polymer pellets.

In certain embodiments of the method, a rotomolded article prepared from the plurality of micronized polymer pellets exhibits an environmental stress crack resistance (ESCR) of at least 500 hours without the observance of cracks or other defects.

In certain embodiments of the method, the rotomolded article prepared from the plurality of micronized polymer pellets exhibits an environmental stress crack resistance (ESCR) of at least 1,000 hours, and in particular, at least 2,000 hours without the observance of cracks or other defects.

In certain embodiments of the method, the rotomolded article exhibits a surface resistivity ranging from about 1×10⁵ to 1×10¹²Ω.

In certain embodiments of the method, the step of adjusting the pressure of the polymer stream comprises increasing the pressure of the polymer stream by a factor at least 2.

In certain embodiments of the method, the step of adjusting the pressure of the polymer stream comprises increasing the pressure of the polymer stream by a factor ranging from 2 to 5.

In certain embodiments, an aspect of the disclosure is directed to a system for preparing micronized polymer pellets having antistat properties.

In certain embodiments of the system, the system comprises
a source of a polymer resin and a source of an antistat agent;
an extruder in communication with the source of the polymer resin and the source of the antistat agent, the extruder being configured and arranged to melt knead the polymer resin and antistat agent to form a molten or semi-molten polymer stream;
a melt pump disposed downstream of the extruder and in fluid communication with the extruder, the melt pump having a proximal and distal end, the melt pump being configured to receive the polymer stream from the extruder and adjust a pressure of the polymer stream to a predetermined pressure threshold;
a die disposed downstream of the melt pump, the die comprising a plurality of fluid channels and a plurality of extrusion orifices each associated with a corresponding fluid channel, wherein the die is configured and arranged to distribute the polymer stream into a plurality of polymer strands; and
a pelletizer disposed downstream of the die, the pelletizer configured and arranged to cut the polymer strands to form a plurality of micronized polymer pellets.

In certain embodiments of the system, the system further comprises a pressure transducer disposed adjacent the distal end of the melt pump, the pressure transducer being configured and arranged to measure a pressure of the polymer stream as it exits the melt pump.

In certain embodiments of the system, a computer in communication with the pressure transducer and the melt pump, the computer comprising executable program code for providing instructions to the melt pump to increase or decrease operational speed of the melt pump and extruder to adjust the pressure of the polymer melt to the predetermined threshold.

In certain embodiments of the system, the system includes a water bath in which the extrusion orifices of the die are submerged in the water bath.

In certain embodiments of the system, the water bath comprises a heated water stream having a temperature from about 70 to 90° C., and wherein said heated water stream is in fluid communication with a dryer unit disposed downstream of the water bath, wherein the heated water stream collects the micronized polymer pellets in the water bath and transports them to the dryer unit

### BRIEF DESCRIPTION OF THE SEVERAL DRAWINGS

Having thus described the invention in general terms, reference will now be made to the accompanying drawings, which are not necessarily drawn to scale, and wherein:

FIG. 1 illustrates a schematic drawing of a system for the preparation of polymer micropellets in accordance with at least one aspect of the disclosure.

### DETAILED DESCRIPTION

The invention now will be described more fully hereinafter with reference to the accompanying drawings, in which some, but not all embodiments of the inventions are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

The terms “first,” “second,” and the like, “primary,” “exemplary,” “secondary,” and the like, do not denote any order, quantity, or importance, but rather are used to distinguish one element from another. Further, the terms “a,” “an,” and “the” do not denote a limitation of quantity, but rather denote the presence of “at least one” of the referenced item.

Each embodiment disclosed herein is contemplated as being applicable to each of the other disclosed embodiments. All combinations and sub-combinations of the various elements described herein are within the scope of the invention.

It is understood that where a parameter range is provided, all integers within that range, and tenths and hundredths thereof, are also provided by the invention. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%.

As used herein, the terms “about.” “approximately,” and “substantially” in the context of a numerical value or range means±10% of the numerical value of range recited or claimed, and in particular, encompasses values within a standard margin of error of measurement (e.g., SEM) of a stated value or variations±0.5%, 1%, 5%, or 10% from a specified value.

For the purposes of the present application, the following terms shall have the following meanings:

As used herein, and unless indicated to the contrary, the term “molecular weight” refers to the weight average molecular weight (Mw), and is expressed in grams/mol. The weight average molecular weight can be determined using commonly known techniques, such as gel permeation chromatography (GPC).

As used herein the term “polymer” generally includes, but is not limited to, homopolymers, copolymers, such as, for example, block, graft, random and alternating copolymers, terpolymers, etc. and blends and modifications thereof. Furthermore, unless otherwise specifically limited, the term “polymer” shall include all possible geometrical configurations of the material, including isotactic, syndiotactic and random symmetries.

As used herein, the terms “micropellet” and “micronized polymer pellet” refer to a pellet comprising a polymer composition and having an average particle size of less than 800 microns.

Certain aspects of the disclosure are directed to a system and process for preparing micronized polymer pellets having desirable particle flow characteristics and high surface resistivity. In addition, aspects of the disclosure are directed a bulk mass comprising a plurality of micronized polymer pellets in which the pellets exhibit an average particle size of less than 800 microns (μm) with a low particle size distribution. In certain embodiments, molded articles prepared using the micronized polymer pellets are characterized by passing the Environmental Stress-Cracking Resistance (ESCR) testing with no observable cracks or defects following 2,000 hours of testing.

In certain embodiments, the disclosure is directed to a bulk mass comprising a plurality of micronized polymer pellets polymer comprises of a first polymer resin, and a polymeric antistatic agent comprising a polyolefin block polymer, an ionic liquid; and a salt. In certain aspects, the disclosure is directed to a micronized polymer pellet having an average diameter of less than 800 microns (μm).

In further aspects of the disclosure, a bulk mass comprising a plurality of micronized polymer pellets is provided in which the micronized polymer pellets comprise a polyolefin composition having a blend of one or more (e.g., a first polyolefin resin and a second polyolefin resin), and a polymeric antistatic agent.

### Polymer Resins

A wide variety of polymers may be used in the preparation of micronized polymer pellets in accordance with embodiments of the present disclosure.

Micronized polymer pellets in accordance with embodiments of the invention may be prepared with a wide variety of different polymers and polymeric blends. Examples of suitable polymers for preparing the fibers include polyolefins, such as polypropylene and polyethylene, and copolymers thereof, polyesters, such as polyethylene terephthalate (PET), polytrimethylene terephthalate (PTT), and polybutylene terephthalate (PBT), nylons, polystyrenes, polyurethanes, copolymers, and blends thereof, and other synthetic polymers that may be used in the preparation of micronized polymer pellets.

In some embodiment, the polymer can be selected from the group consisting of: polyolefins, polyesters, polyethylene terephthalates, polybutylene terephthalates, polycyclohexylene dimethylene terephthalates, polytrimethylene terephthalates, polymethyl methacrylates, polyamides, nylons, polyacrylics, polystyrenes, polyvinyls, polytetrafluoroethylenes, ultrahigh molecular weight polyethylenes, very high molecular weight polyethylenes, high molecular weight polyethylenes, polyether ether ketones, non-fibrous plasticized celluloses, polyethylenes, polypropylenes, polybutylenes, polymethylpentenes, low-density polyethylenes, linear low-density polyethylenes, high-density polyethylenes, polystyrenes, acrylonitrile-butadiene-styrenes, styrene-acrylonitriles, styrene tri-block and styrene tetra block copolymers, styrene-butadienes, styrene-maleic anhydrides, ethylene vinyl acetates, ethylene vinyl alcohols, polyvinyl chlorides, cellulose acetates, cellulose acetate butyrates, plasticized cellulosics, cellulose propionates, ethyl cellulose, and any derivative thereof, any polymer blend thereof, any copolymer thereof or any combination thereof.

In certain embodiments, the polymers for use in the micronized polymer pellets preferably comprise a polyolefin, such as a polypropylene, polyethylene, a blend of a polypropylene and polyethylene, and combinations thereof.

A wide variety of polypropylenes may be used in embodiments of the invention typically have molecular weights greater than about 100,000 g/mol, and more typically, may have molecular weights ranging from about 150,000 to about 300,000 g/mol. In one embodiment, the polypropylene may have a molecular weights ranging from about 160,000 to about 250,000 g/mol, and in particular, from about 160,000 to about 180,000 g/mol.

In certain embodiments for the preparation of the micronized polymer pellets, polypropylenes that may be used have an MFR that is typically from about 1 to 20 g/10 min, and in particular, from about 1 to 10 g/10 min, with an MFR from about 2 to 6 g/10 min being somewhat more typical. Unless otherwise indicated MFR is measured in accordance with ASTM D-1238.

Examples of such polypropylenes may include those available from Invista, such as P6G4A-136 (5.5 MFR g/10 min. and a density of 0.90 g/cm³) and Ineos, such as N05U-pp 3155E5 (5.0 MFR g/10 min. and a density of 0.907 g/cm³).

In some embodiments, the polyolefin may comprise a polyethylene polymer. Various types of polyethylene polymers may be employed in the fibers of the present invention. As an example, a high density polyethylene, a branched (i.e., non-linear) low density polyethylene, or a linear low density polyethylene (LLDPE) can be utilized. Polyethylenes may be produced from any of the well-known processes, including metallocene and Ziegler-Natta catalyst systems. Generally, the polyethylene polymers that are conventionally used in the production of molded articles may be suitable for use in the present invention.

In certain embodiments for the preparation of the micronized polymer pellets, polyethylenes that may be used have an MFR that is typically from about 1 to 20 g/10 min, and in particular, from about 1 to 10 g/10 min, with an MFR from about 2 to 7 g/10 min being somewhat more typical. Unless otherwise indicated MFR is measured in accordance with ASTM D-1238.

In one embodiment of the invention, the polyethylene component comprises a polyethylene having a density ranging from about 0.90 to 0.97 g/cm³ (ASTM D-792).

Examples of suitable polyethylenes included LUMICENE™ mPE M4041 UV (a metallocene catalyzed polyethylene polymer resin having a melt index of 4.0 g/10 min. and a density of 0.939 g/cm³ (ASTM D-792)) available from Baystar, and Petrothene GA635962 available from Lyondell Basell (a polyethylene resin having a melt index of 6.7 g/10 min. and a density of 0.935 g/cm³ (ASTM D-792)); Additional polyethylene resins are available from Shell Polymers and include product number 35R7U (a linear low density polyethylene having a melt index of 7.0 g/10 min and a density of 0.935 g/cm³ (ASTM D-792)); product number 39R4U (a linear low density polyethylene having a melt index of 3.5 g/10 min and a density of 0.939 g/cm³ (ASTM D-792)); and product number 39R4U (a linear low density polyethylene having a melt index of 5.2 g/10 min and a density of 0.935 g/cm³ (ASTM D-792). Also suitable include polyethylene resins available from Chevron Phillips under the trade name MARLEX®, such as HMN TR-942 (a high density polyethylene having a melt index of 2.0 g/10 min and a density of 0.943 g/cm³ (ASTM D-1505)).

LLDPE may also be used in some embodiments of the present invention. LLDPE is typically produced by a catalytic solution or fluid bed process under conditions established in the art. The resulting polymers are characterized by an essentially linear backbone. Density is controlled by the level of comonomer incorporated into the otherwise linear polymer backbone. Various alpha-olefins are typically copolymerized with ethylene in producing LLDPE. The alpha-olefins which preferably have four to eight carbon atoms, are present in the polymer in an amount up to about 10 percent by weight. The most typical comonomers are butene, hexene, 4-methyl-1-pentene, and octene. In general, LLDPE can be produced such that various density and melt index properties are obtained which make the polymer well suited for melt-spinning with polypropylene. Preferably, the LLDPE should have a melt index of greater than 20, and more preferably no greater than 10 for rotomolding applications. Particularly preferred are LLDPE polymers having a density of 0.90 to 0.97 g/cm³ and a melt index of greater than 2.

In certain embodiments, the polymer composition may comprise a polymer blend of two or more polyethylene resins, such as a blend of one or more of a low density polyethylene, linear low density polyethylene, medium density polyethylene, and a high density polyethylene.

In certain embodiments, the polymer composition may include an additional polyolefin resin having a carbonyl or acetate group. For example, the polymer composition may include a blend of one or more polyethylene resins with an ethylene vinyl acetate (EVA) resin. Suitable EVA resins generally have an MFR from about 1-20 g/10 min., and in particular, from about 1-10 g/10 min., and more particularly, from about 2-7 g/10 min. Examples of EVA copolymer resins include Celanese ATEVA® 1030 (1.5 MFR g/10 min. and a density of 0.93 g/cm³) and ATEVA® 1820 (3.0 MFR g/10 min. and a density of 0.938 g/cm³).

In some embodiments, the polymers may be extensible and/or elastic.

In some embodiments, the polymers may comprise polymers derived from mechanically or chemically recycled feedstocks. For example, up to 100% of the polymer resin comprising the micronized polymer pellets may be derived from recycled polymers.

The amount of polymer resin in the polymer composition typically ranges from about 50 to 95 weight percent, based on the total weight of the polymer composition, and in particular, from about 65 to 90 weight percent, and more particular from about 75 to 90 weight percent, based on the total weight of the polymer composition.

### Antistat Agent

The polymer composition comprises a blend of a polymer base resin and an antistat agent. In certain embodiments, the antistat agent comprises 1) a copolymer of a hydrophobic polymer and a hydrophilic polymer; 2) an ionic liquid; and 3) a salt.

The copolymer of a hydrophobic polymer and a hydrophilic polymer is not particularly limited provided it has an antistatic ability. Examples of antistat agents that may be used are described in JP 2001-278985 A, JP 2013-213195 A, JP 2015-096595 A, JP 2016-166332 A, JP 2017-101217 A, U.S. Pat. Nos. 7,723,418 and 11,655,370, the contents of which are all incorporated by reference.

More specific examples include polyethers having a hydrophilic group and being block copolymerized (nonionic types such as polyether ester amides, ethylene oxide-epichlorohydrins, and polyether esters, anionic types such as polystyrene sulfonic acids, and cationic types such as quaternary ammonium-containing poly(meth)acrylates). Among them, a block copolymer having a structure in which a polyether block and a polyolefin block are repeatedly and alternately joined via at least one bond selected from an ester bond, an amide bond, an ether bond, a urethane bond, and an imide bond can be used, and an example thereof is a block copolymer having a structure in which a polyether block, which is a hydrophilic block having a volume resistivity of 10⁵ to 10¹¹ Ω·cm, and a polyolefin block are repeatedly and alternately joined. The number average molecular weight (Mn) of the block copolymer is preferably 2.000-60,000.

Examples of ionic liquids may include poly(ethylene glycol)-based ionic liquids comprising a salt.

Salts for use in the antistat agent may include a room-temperature molten salt that has a melting point at or below room temperature, and where at least one of the cations or anions constituting (A) is an organic ion, with an initial electrical conductivity of 1 to 200 mS/cm, preferably 10 to 200 mS/cm, and more preferably 20 to 200 mS/cm. Examples of such room-temperature molten salts include those described in WO95/15572.

An initial electrical conductivity of less than 1 mS/cm results in poor antistatic properties, and those exceeding 200 mS/cm are difficult to synthesize. Here, “initial electrical conductivity” refers to the conductivity measured immediately after starting the measurement at 30° C. using a specific conductance measuring device.

Further examples of cations and anions constituting are described in JP 4625255 B2.

Examples of salts for use in the antistat agent include cations and anions constituting (A). It can include salts of organic acids with alkali metals (such as lithium, sodium, potassium) and/or alkaline earth metals (such as magnesium, calcium). These organic acids include monocarboxylic and dicarboxylic acids with carbon chain lengths of C1 to C12 (such as formic acid, acetic acid, propionic acid, oxalic acid, succinic acid), sulfonic acids with carbon chain lengths of C1 to C20 (such as methanesulfonic acid, p-toluenesulfonic acid, trifluoromethanesulfonic acid), and thiocyanic acid. Additionally, salts of inorganic acids such as halogenated hydroacids (like hydrochloric acid, hydrobromic acid), perchloric acid, sulfuric acid, nitric acid, and phosphoric acid may also be used. Additional salts that may be used are described in JP 4786628 B2.

Suitable examples of commercially available antistat agents include those under the proprietary names PELESTAT® (PELESTAT 300. PELESTAT 230, PELESTAT NC6321. PELESTAT NC6322, “PELESTAT NC7350, PELESTAT HC250, etc.) and PELECTRON® (PELECTRON PVH, PELECTRON PVL, PELECTRON HS, and PELECTRON LMP-FS, etc.) manufactured by Sanyo Chemical Industries, Ltd.,

Typically, the amount of the antistat agent in the polymer composition is from about 5 to 50 weight percent, based on the total weight of the polymer composition.

In certain embodiments, the amount of the antistat agent in the polymer composition is from about 10 to 35 weight percent, based on the total weight of the polymer composition, and in particular from about 12 to 18 weight percent, based on the total weight of the polymer composition.

### Optional Additives

In certain embodiments, the polymer composition may include additional additive components, such as flame retardants, antioxidants, impact modifiers, UV stabilizers, elastomers, water/oil repellent agents, pigments, colorants such as dyes, mold release agents such as silicone oil and alkyl esters, and the like. In some embodiments, the polymer composition may include from about 0.2 to 5 weight percent of additional additives, and in particular, from about 0.3 to 1.0 weight percent, based on the total weight of the polymer composition.

In certain embodiments, the polymer composition may comprise one or more antioxidants. When present, the amount of antioxidants in the polymer composition may range from 0.01 to 1.0 weight percent, and in particular from about 0.02 to 0.1 weight percent, and more particularly, from about 0.05 to 0.1 weight percent. In certain embodiments, the polymer composition may comprise a primary antioxidant and a secondary antioxidant.

Examples of suitable elastomeric components may include polyolefin based elastomers, such as alpha-olefin copolymers, styrene elastomers, such as styrene-ethylene-butylene-styrene block copolymers (SEBS), and combinations thereof.

In certain embodiments, the polymer composition preferably includes an SEBS. Suitable examples of SEBS include those available from Kuraray under the trade designation SEPTON® (e.g., SEPTON® 8006), SEBS available from Kraton Performance Polymers under the trade designation KRATON G1650, KRATON G 1651, KRATON G1652, and triblock copolymer resins are available from Dynasol under trade designation of CH-6110 and CH-6174.

In certain embodiments, the polymer composition comprises a polyolefin elastomer (POE). For example, in some embodiments, a suitable POE may be a polypropylene based ethylene elastomer. In some embodiments, a POE comprising a propylene/α-olefin copolymer available from Exxon Mobil under the tradename VISTAMAXX™ (e.g., 6202, 6100, 6102 and/or 3,000). Additional polyolefin elastomers that may be used in certain embodiments are commercially available under the trade designation EXACT (e.g., EXACT 3024, 3040, 4011, 4151, 5181, and 8210) Other exemplary polyolefin elastomer are commercially available under the trade designations AFFINITY (e.g., AFFINITY PT 1845G, PL 1845G, PF 1140G, PL 1850G, and PL 1880G), ENGAGE (e.g., ENGAGE 8003), and INFUSE (e.g., INFUSE D9530.05) from Dow Chemical (Midland, Mich.).

Many commercially available comprise olefin copolymers which are the reaction product of ethene with a second alkene selected from butene, hexene, or octene. EXACT 3024 and EXACT 4011 are ethylene-butene copolymers. EXACT 3040 and EXACT 4151 are ethylene-hexene copolymers. EXACT 8210, EXACT 5181, ENGAGE 8003, and INFUSE D9530.05 are ethylene-octene copolymers.

One method of producing such a POE may comprise blending a first polymer component with a second polymer component. The first polymer component may be a predominately crystalline stereoregular polypropylene. The second polymer component may be a crystallizable copolymer of a C2, C4-C20 alpha-olefin and propylene. Other, possibly optional, components of the blend may include the second polymer component, may include crystallizable copolymer of a C2, C4-C20 alpha-olefin (preferably ethylene), and process oil.

When present, the amount of elastomeric component in the polymer composition may range from 2 to 35 weight percent, and in particular from about 3 to 20 weight percent, and more particularly, from about 4 to 10 weight percent. In certain embodiments, the amount of elastomeric component in the polymer composition may range from about 4 to 6 weight percent, based on the total weight of the polymer composition.

In certain embodiments, the composition comprises from about 70 to 85 weight percent of a polyolefin resin (e.g., polypropylene), from about 5 to 20 weight percent of the antistat agent, and from about 5 to 15 weight percent of a polyolefin elastomer. In a preferred embodiment, the composition may comprise from about 75 to 80 weight percent of the polyolefin resin, 12 to 18 weight percent of the antistat agent, and from about 6 to 10 weight percent of a polyolefin elastomer.

### Properties of the Micronized Polymer Pellets

In certain embodiments, the polymer composition in accordance with embodiments of the disclosure exhibit desirable properties with respect to surface resistivity,

In certain embodiments, the polymer composition comprising the micronized polymer pellets, and hence a molded article prepared from the polymer composition exhibits a surface resistivity of less than 1×10¹³Ω. In particular, the polymer composition may exhibit a surface resistivity ranging from about the 1×10⁵ to 1×10¹²Ω, and more particularly, from about 1×10⁸ to 1×10¹¹Ω, and even more particularly from about 1×10⁹ to 1×10¹⁰Ω. Advantageously, polymer compositions having the above noted surface resistivities exhibit stable electrostatic dissipating properties.

In certain embodiments, aspects of the invention are directed to a bulk polymer composition comprising a plurality of micronized polymer pellets having an average particle size of less than 800 microns (μm). Advantageously, polymer micronized polymer pellets in accordance with certain embodiments of the invention are particularly suited for use in molding applications, such as rotomolding.

In certain embodiments, the polymeric mass comprising a plurality of micronized polymer pellets exhibit a relatively narrow particle size distribution.

In certain embodiments, the micronized polymer pellets exhibit an average particle size ranging from about 350 to 600 μm, and more particularly, from about 400 to 500 μm, and even more particularly, from about 425 to 475 μm. In certain embodiments, the plurality of micronized polymer pellets exhibit an average particle size of less than 500 μm with a standard deviation of less than 50 μm, and in particular, an average particle size of less than 450 μm with a standard deviation of less than 50 μm.

In certain embodiments, the polymeric mass comprising a plurality of micronized polymer pellets exhibits a D90 of 600 μm and a D10 of 300 μm. In certain embodiments, the plurality of micronized polymer of the disclosure has a substantially narrow particle size distribution. In particular embodiments the 90/10 ratio of particle sizes of the material is from 625-325; from 575-375 or from 500-400.

In a preferred embodiment, the plurality of micronized polymer pellets exhibit an average particle size of 450 μm with 80% of the particles having a particle size preferably within 50 microns of the average particle size, and more preferably within 40 microns of the average particle size. In certain embodiments, the plurality of micronized polymer pellets exhibit an average particle size of 450 μm with 80% of the particles having a particle size preferably within 25 microns of the average particle size.

In certain embodiments, molded articles comprising the micronized polymer pellets of the present disclosure exhibit excellent stress crack resistance. More specifically, the molded article may exhibit an environmental stress crack resistance (ESCR) of at least 250 hours. In certain aspects, the molded article may have an ESCR of at least 500 hours, at least 750 hours, at least 1,000 hours, at least 1,500 hours, at least 1,750 hours, or at least 2,000 hours, and often can range as high as 2,500 to 4,000 hours. Typically, the ESCR test is halted after a certain number of hours is reached, and given the long duration of the test, the upper limit of ESCR (in hours) is generally not determined. ESCR testing and test results disclosed herein are in accordance with ASTM D1693, condition B, 10% igepal, which is considered a more stringent test than ESCR testing conducted using a 100% igepal solution.

In certain embodiments, the micronized polymer pellets exhibit excellent flow characteristics as determined in accordance with Falling Time and Angle of Repose.

In certain embodiments, the plurality of micronized polymer pellets exhibit a Falling time ranging from about 7 to 20 seconds, and in particular, from about 10 to 15 seconds. In certain embodiments, the plurality of micronized polymer pellets exhibit a falling time from about 10 to 12 seconds. Falling time is measured in accordance with the Test Method for Flowability (Dry Flow Rate) and Apparent Density (Bulk Density) of Polyethylene Powders set forth by the Association of Rotational Molders (Version 2.1 (November 2011).

In certain embodiments the plurality of micronized polymer pellets exhibit a falling time of one or more of the following: a falling time less than 20 seconds, a falling time less than 19 seconds, a falling time less than 18 seconds, a falling time less than 17 seconds, a falling time less than 16 seconds, a falling time less than 15 seconds, a falling time less than 14 seconds, a falling time less than 13 seconds, a falling time less than 12 seconds, a falling time less than 11 seconds, a falling time less than 10 seconds, a falling time less than 9 seconds, a falling time less than 8 seconds, or a falling time less than 7 seconds.

In certain embodiments, the plurality of micronized polymer particles exhibit an Angle of Repose ranging from about 25 to 45 degrees, and in particular, from about 30 to 38 degrees, and more particularly, from about 32 to 36 degrees. Angle of Repose may be measured in accordance with ASTM D6393-08.

In certain embodiments, a polymeric mass comprising the plurality of micronized polymer pellets are characterized by exhibiting an average particle size ranging from 400 to 500 μm with a standard deviation of less than 50 μm and a surface resistivity ranging from about 1×10⁵ to 1×10¹²Ω.

In certain embodiments, a polymeric mass comprising the plurality of micronized polymer pellets are characterized by exhibiting a Falling Time ranging from about 10 to 15 seconds and an Angle of Repose ranging from about 30 to 38 degrees.

In certain embodiments, a polymeric mass comprising the plurality of micronized polymer pellets are characterized by the following:
a) an average particle size ranging from 400 to 500 μm with a standard deviation of less than 50 μm;
b) a surface resistivity ranging from about 1×10⁵ to 1×10¹²Ω;
c) a Falling time ranging from about 10 to 15 seconds; and
d) an Angle of Repose ranging from about 30 to 38 degrees.

In certain embodiments, a polymeric mass comprising the plurality of micronized polymer pellets are characterized by the following:
a) an average particle size of about 450 μm with a standard deviation of less than 25 μm;
b) a surface resistivity ranging from about 1×10⁹ to 1×10¹⁰Ω;
c) a Falling time ranging from about 10 to 12 seconds; and
d) an Angle of Repose ranging from about 30 to 38 degrees.

### System and Method for Preparing Micronized Polymer Pellets

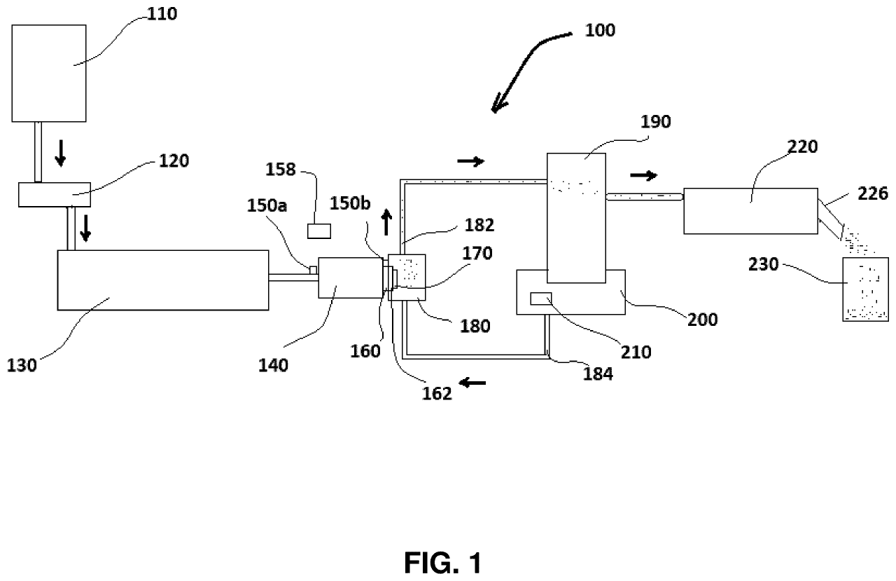

With reference to FIG. 1, an example of a system for preparing micronized polymer pellets is schematically illustrated and broadly designated by reference character 100.

The system 100 includes one or more sources of polymeric and additive components that are blended to form a polymer composition. For example, the system may include a source of the polymer resin, a source of antistat agent, a source of polymeric elastomer, and a source of one or more additional additives. In the illustrated embodiment, the system includes a high intensity mixer 110 in which the individual components of the polymer composition are introduced and mixed to provide a mixed material comprising a polymer resin and an antistat agent. In certain embodiments, each component of the polymer composition is metered into the high intensity mixer and subsequently mixed in batches.

Alternatively, the system may be configured to continuously meter in each component of the polymer composition to provide a continuous process of preparing the polymer micropellets. For example, the high intensity mixer may be in communication with one or more sources of polymer (e.g., a first polymer source, a second polymer source, a third polymer source, etc.), an antistat agent source, and one or more additive sources (e.g., antioxidant source, elastomeric source, UV stabilizer source, etc.), which are configured to continuously introduce the individual components into the high intensity mixer at a desired rate and ratio.

In certain embodiments, the mixed material is then introduced into a volumetric feeder 120 disposed downstream of the high intensity mixer. The mixed material is then fed into an extruder 130 downstream of the volumetric feeder. The extruder may be a single or twin extruder, such as an extruder available from Coperion.

In the extruder 130, the components of the polymer composition are heated above the melting point of the polymer resins and melt kneaded to provide a molten or semi-molten polymer stream comprising the polymer composition. For a polyolefin composition, the polymer composition is typically heated to a temperature from about 180 to 210° C.

The stream of semi-molten or molten polymer is then introduced into a melt pump 140. The melt pump is disposed downstream of the extruder and is in fluid communication with the extruder. The melt pump includes a proximal and distal end. The proximal end of the melt pump is disposed upstream and the distal end of the melt pump is disposed downstream. In certain embodiments, the melt pump comprises a high pressure melt pump configured and arranged to adjust the pressure of the polymer stream as it is discharged from the melt pump. Suitable melt pumps are available from PSI and Lewa.

A micropellet forming die 160 is disposed downstream of the melt pump. The micropellet forming die comprises a plurality of fluid channels that are in communication with a die outlet surface 162 of the micropellet forming die 160. As the polymer stream is introduced into the micropellet forming die, the polymer stream is distributed into the plurality of fluid channels. Each fluid channel is in communication with an associated extrusion orifice (not shown) formed in the die outlet surface 162. The number of fluid channels and associated extrusion orifices may range from about 200 to 3000, and in particular, from about 1200 to 2,800, and more particularly, from about 2,000 to 2,400.

Typically, the micropellet forming die 160 is maintained at a higher temperature relative to the temperature of the polymer stream exiting the extruder 130. For example, the micropellet forming die 160 may be maintained at a temperature ranging from about 260 to 360° C.

For the preparation of micronized polymer pellets, it is generally desirable for the extrusion orifices to have diameters ranging from about 0.20 to 0.50 mm, and in particular, from about 0.25 to 0.45 mm, and more particularly, from about 0.34 to 0.38 mm.

As the polymer stream is introduced into the micropellet forming die, the molten polymer is divided and flows into the plurality of fluid channels which form polymer strands. As the polymer strands exit the micropellet forming die, a pelletizer 170 cuts the polymer strands into discrete polymer particles (e.g., micropellets). Suitable pelletizers are available from Gala.

Generally, it has been observed that in order to produce micronized polymer pellets suitable for use in rotomolding applications, it is desirable for the micronized polymer pellets to have average diameters of less than 800 microns with a relatively narrow distribution range. For example, at least 80 percent of the micronized polymer pellets have a particle size within 50 microns of the average particle size for the given batch of micropellets. To achieve this result, the inventors have discovered that the pressure of the polymer stream prior to being introduced into the micropellet forming die should be elevated relative to the pressure of the polymer stream as it exits the extruder. Typically, the pressure of the polymer stream is increased by a factor of at least 2, and more preferably, by a factor ranging from 2 to 5 prior to being introduced into the micropellet forming die. The optimal increase in the pressure of the polymer stream will generally be determined based on the composition of the polymer resin as it may vary depending on the chemistry of the polymer resin.

In certain embodiments, the pressure of the polymer stream is increased by at least a factor of 2.0, at least 2.1, at least 2.2, at least 2.3, at least 2.4, at least 2.5, at least 2.6, at least 2.7, at least 2.8. at least 2.9, at least 3.0, at least 3.1, at least 3.2, at least 3.3. at least 3.4, at least 3.5, at least 3.6, at least 3.7, at least 3.8, at least 3.9, at least 4.0, at least 4.1, at least 4.2, at least 4.3, at least 4.4, at least 4.5, at least 4.6. at least 4.7, at least 4.8, at least 4.9, and at least 5.0 prior to the polymer stream being introduced into the micropellet forming die.

In certain embodiments, the pressure of the polymer stream prior to being introduced into the micropellet die is increased by a factor of no more than 5.0, of no more than 4.9, of no more than 4.8, of no more than 4.7, of no more than, 4.6, of no more than 4.5, of no more than 4.5, of no more than 4.4, of no more than 4.3, of no more than 4.2, of no more than 4.1, of no more than 4.0, of no more than 3.9, of no more than 3.8, of no more than 3.7, of no more than 3.6, of no more than 3.5, of no more than 3.4, of no more than 3.3, of no more than 3.2, of no more than 3.0, of no more than 2.9, of no more than 2.8, of no more than 2.7, of no more than 2.6, of no more than 2.5, of no more than 2.4, of no more than 2.3, of no more than 2.2, of no more than 2.1, and of no more than 2.0.

In certain embodiments, the pressure of the polymer stream exiting the melt pump is increased by a factor ranging from about 2.0 to 5.0, and in particular, from about 2.0 to 3.6, and more particularly, from about 2.4 to 3.0.

To assist in monitoring and adjusting the pressure of the polymer stream exiting the micropellet forming die 160, the system may include one or more pressure transducers. In the illustrated embodiment, the system includes a first pressure transducer 150a that is disposed between the extruder 130 and the melt pump 140, and a second pressure transducer 150b disposed between the melt pump and the micropellet forming die. For example, the second pressure transducer may be positioned within or adjacent to an outlet of the melt pump.

In certain embodiments, the first and second pressure transducers 150a, 150b are in communication with a computer or similar device (e.g., a Programmable Logic Controller (PLC)) 158 that is also in communication with the melt pump 140 and the extruder 130. The computer (hereinafter referred to simply as the “PLC”) may comprise executable program code to adjust the operational speed of the melt pump to achieve a predetermined pressure threshold.

The connection between the pressure transducers, melt pump, extruder, and PLC may be wired or wireless. During operation, the PLC receives pressure data measurements from the transducers and, based on these measurements, provides instructions to the melt pump and/or extruder on whether to accelerate or decrease the operational speed of the melt pump in order to maintain the pressure of the polymer stream at a predetermined pressure threshold for a given polymer composition. The communication between the transducers, the melt pump, extruder, and the PLC may be continuous so that the pressure of the polymer stream exiting the melt pump exhibits a variance of no more than 3 percent, and preferably, no more than 2 percent.

As discussed previously, the predetermined pressure threshold of the polymer stream prior to being introduced into the micropellet forming die will generally be determined based on the composition of the polymer resin being extruded as it may vary depending on the chemistry of the polymer resin. In certain embodiments, the desired pressure of the polymer stream prior to exiting the micropellet forming die will be inputted into the PLC by an operator (the predetermined pressure threshold may be determined based on targeted particle size of the micropellets and targeted properties). This may be achieved by manually inputting the desired pressure or by using other means, such as wirelessly communicating the desired pressure. In some embodiments, the PLC will comprise a non-transitory storage medium device having stored files (e.g., executable program code) for various polymer compositions, which will also include associated predetermined pressure threshold ranges for a given polymer composition. In this way, the appropriate predetermined pressure threshold may be selected by selecting the polymer composition that is to be extruded.

Referring back to FIG. 1, a distal portion of the micropellet forming die is disposed within a water bath 180 so that as the polymer strands are discharged through the extrusion orifices, they are discharged directly into the water bath. 180. Preferably, the distal end of the micropellet forming die (the downstream end) is partially submerged in the water bath so that the extrusion orifices are also submerged in the water bath.

In certain embodiments, the water bath 180 comprises a stream of heated water that is introduced into the water bath via fluid conduit 184. Typically, the stream of heated water is heated to a temperature ranging from about 70 to 90° C., and in particular from about 76 to 84°C. The stream of heated water is provided from water source 200. The stream of heated water may be introduced into the water bath 180 at a rate ranging from about 50 to 80 gallons/minute, and in particular from about 55 to 70 gallons/minute.

As the stream of heated water is introduced into the water bath 180, the stream of heated water picks up and collects the recently formed micronized polymer pellets. The stream collectively comprising the heated water and micronized polymer pellets flows out of the water bath 180 via fluid discharge conduit 182. Fluid discharge conduit 182 is in fluid communication with a fluid inlet of a dryer unit 190 at which point the stream comprising the heated water and micronized polymer pellets is introduced into the dryer unit 190. In certain embodiments, the dryer unit comprises a centrifugal dryer.

In the dryer unit (e.g., a centrifugal dryer), the micronized polymer pellets are separated from the water and dried. The water is returned to water source 200. A heater 210 may be disposed in the water source 200 to heat the water to a desired temperature.

Alternatively, a water heater may be disposed along fluid conduit between the water source 200 and the water bath 180. In a preferred embodiment, the heated water stream is continuously circulated between the water bath and the water source.

Following separation of the micronized polymer pellets from the water, the micronized polymer pellets may optionally be introduced into a classifier to screen out and separate individual pellets that do not fall within the desired particle size distribution range. Suitable particle classifiers are available from Witte.

Next, the micronized polymer pellets may be discharged from the classifier 220 via outlet 226 and introduced into an appropriate storage container, such as a bag or other container.

Aspects of the disclosure are also directed to the preparation of rotomolded articles.

In a rotomolding process, the polymeric material is added in the rotomold mold. After the feeding, the mold is closed with the aid of clamps or screws, and then it is taken to a furnace in biaxial rotation movement. The synergistic effect between the heat received from the furnace and the biaxial movement results in uniform heating of the material inside the mold. When the softening temperature of the polymer is reached inside the mold, it begins to adhere to the surface of the mold. The material remains in the furnace for a period sufficient for the parts to be completely molded.

Still in motion, the mold is withdrawn from the chamber and the cooling process begins, which may occur at ambient temperature, forced air jet and/or water spray or even more complex systems such as cooling sleeves enclosing the mold.

In certain embodiments, a rotomolded article is provided that is prepared with the micronized polymer pellets in accordance with certain embodiments of the disclosure. As noted previously rotomolded articles prepared with the micronized polymer pellets exhibit excellent surface resistivity and are characterized by passing the ESCR following 1,000 hours of evaluation without observance of cracks or other defects in the molded article.

In certain embodiments, the rotomolded article prepared from the micronized polymer pellets may exhibits a surface resistivity of less than 1×10¹³Ω. In particular, the rotomolded article may exhibit a surface resistivity ranging from about the 1×10⁵ to 1×10¹²Ω, and more particularly, from about 1×10⁸ to 1×10¹¹Ω, and even more particularly from about 1×10⁹ to 1×10¹⁰Ω. Advantageously, rotomolded articles having the above noted surface resistivities exhibit stable electrostatic dissipating properties.

In certain embodiments, aspects of the disclosure are directed to a rotomolded article in the form of a tank, such as a fuel tank, having a surface resistivity of less than 1×10¹³Ω, and in particular, a surface resistivity ranging from about the 1×10⁵ to 1×10¹²Ω, and more particularly, from about 1×10⁸ to 1×10¹¹Ω, and even more particularly from about 1×10⁹ to 1×10¹⁰Ω.

### SUMMARY OF REPRESENTATIVE EMBODIMENTS

Paragraph 1: Certain embodiments provide a bulk polymer composition having a plurality of micronized polymer pellets comprising a blend of a polymer resin and an antistatic agent, the plurality of polymer particles having an average particle size of less than 800 microns (μm), and wherein the polymer composition exhibits a surface resistivity of less than 1×10¹³Ω.

Paragraph 2: Certain embodiments are directed to the bulk polymer composition of preceding Paragraph 1 in which the polymer resin is selected from the group consisting of polyolefins, nylons, polycarbonates, and polyesters.

Paragraph 3: Certain embodiments are in accordance with Paragraphs 1 or 2 in which the polymer comprises a polyolefin.

Paragraph 4: Certain embodiments are in accordance with Paragraph 3 in which the polyolefin is selected from polyethylene, polypropylene, and blends thereof.

Paragraph 5. Certain embodiments are in accordance with Paragraph 4 in which the polyolefin is selected from the group consisting of linear low density polyethylene (LLDPE), low density polyethylene (LDPE), (mid density polyethylene (MDPE) and high density polyethylene (HDPE), and blends thereof.

Paragraph 6: Certain embodiments are in accordance with Paragraphs 1 to 5 in which the polymer resin comprises a blend of a LLDPE and a HDPE.

Paragraph 7: Certain embodiments are in accordance with Paragraph 6 in which the amount of LLDPE in the blend is from about 5 to 95 weight percent and the amount of HDPE in the blend is from about 5 to 95 weight percent, based on the total weight of the polymer composition.

Paragraph 8: Certain embodiments are in accordance with Paragraphs 1 to 7 in which the bulk polymer composition further comprises ethylene vinyl acetate.

Paragraph 9: Certain embodiments are in accordance with one or more of Paragraphs 1 to 8 in which the bulk polymer composition further comprises a propylene based α-olefin copolymer, styrene-ethylene-butylene-styrene block copolymer, or a blend thereof.

Paragraph 10: Certain embodiments are in accordance with one or more of Paragraphs 1 to 9 in which the antistat agent comprises a copolymer of a hydrophobic polymer and a hydrophilic polymer, an ionic liquid, and a salt.

Paragraph 11: Certain embodiments are in accordance with one or more of Paragraphs 1 to 9 in which an amount of antistat agent in the polymer composition is from about 5 to 35 weight percent, and in particular, from about 10 to 20 weight percent, based on the total weight of the composition.

Paragraph 12: Certain embodiments are in accordance with Paragraph 10 in which the bulk polymer composition further comprises one or more of an antioxidant, a styrene containing elastomer, and a UV stabilizer.

Paragraph 13: Certain embodiments are in accordance with one or more of Paragraphs 1 to 12 in which the plurality of micronized polymer pellets exhibit an average particle size of less than 500 μm with a standard deviation of less than 50 μm.

Paragraph 14: Certain embodiments are in accordance with one or more of Paragraphs 1 to 13 in which the plurality of micronized polymer pellets are characterized by exhibiting a Falling Time ranging from about 10 to 15 seconds and an Angle of Repose ranging from about 30 to 38 degrees.

Paragraph 15: Certain embodiments are in accordance with one or more of Paragraphs 1 to 14 in which the plurality of micronized polymer pellets are characterized by exhibiting an average particle size ranging from 400 to 500 μm with a standard deviation of less than 50 μm and a surface resistivity ranging from about 1×10⁵ to 1×10¹²Ω.

Paragraph 16: Certain embodiments are in accordance with one or more of Paragraphs 1 to 15 in which the plurality of micronized polymer pellets are characterized by the following:
a) an average particle size ranging from 400 to 500 μm with a standard deviation of less than 50 μm;
b) a surface resistivity ranging from about 1×10⁵ to 1×10¹²Ω;
c) a Falling time ranging from about 10 to 15 seconds; and
d) an Angle of Repose ranging from about 30 to 38 degrees.

Paragraph 17: Certain embodiments are in accordance with one or more of Paragraphs 1 to 16 in which the plurality of micronized polymer pellets are characterized by the following:
a) an average particle size of about 450 μm with a standard deviation of less than 25 μm;
b) a surface resistivity ranging from about 1×10⁹ to 1×10¹⁰Ω;
c) a Falling time ranging from about 10 to 12 seconds; and
d) an Angle of Repose ranging from about 30 to 38 degrees

Paragraph 18: Certain embodiments are in accordance with one or more of Paragraphs 1 to 17 in which a rotomolded article prepared from the plurality of micronized polymer pellets exhibits an environmental stress crack resistance (ESCR) of at least 500 hours without the observance of cracks or other defects.

Paragraph 19: Certain embodiments are in accordance with one or more of Paragraphs 1 to 18 in which a rotomolded article prepared from the plurality of micronized polymer pellets exhibits an environmental stress crack resistance (ESCR) of at least 1,000 hours without the observance of cracks or other defects.

Paragraph 20: Certain embodiments are in accordance with one or more of Paragraphs 1 to 19 in which a rotomolded article prepared from the plurality of micronized polymer pellets exhibits an environmental stress crack resistance (ESCR) of at least 2,000 hours without the observance of cracks or other defects.

Paragraph 21: Certain embodiments are in accordance with one or more of Paragraphs 18 to 20 in which the rotomolded article exhibits a surface resistivity ranging from about 1×10⁵ to 1×10¹²Ω.

Paragraph 22: Certain embodiments are in accordance with one or more of Paragraphs 1 to 21 in which the composition comprises
from about 70 to 85 weight percent of a polyolefin resin (e.g., polyethylene);
from about 5 to 20 weight percent of the antistat agent, and
from about 5 to 15 weight percent of a polyolefin elastomer, based on the total weight of the polymer composition.

Paragraph 23: Certain embodiments are in accordance with one or more of Paragraphs 1 to 22 in which the polyolefin resin comprises a high density polyethylene, the antistat agent comprises a copolymer of a hydrophobic polymer and a hydrophilic polymer, an ionic liquid, and a salt, and the polyolefin elastomer comprises a propylene based alpha-olefin copolymer.

Paragraph 24: Certain embodiments are in accordance with Paragraph 23 in which the polyolefin resin is present in an amount from about 75 to 80 weight percent, the antistat agent is present in an amount from about 12 to 18 weight percent, and the polyolefin elastomer is present in an amount from about 6 to 10 weight percent, based on the total weight of the polymer composition

Paragraph 25: Certain embodiments are in accordance with one or more of Paragraphs 21 to 24 in which the plurality of micronized polymer pellets are characterized by the following:
a) an average particle size ranging from 400 to 500 μm with a standard deviation of less than 50 μm;
b) a surface resistivity ranging from about 1×10⁵ to 1×10¹²Ω;
c) a Falling time ranging from about 10 to 15 seconds; and
d) an Angle of Repose ranging from about 30 to 38 degrees.

Paragraph 26: Certain embodiments are directed to a method of preparing a micronized polymer pellets comprising the steps of:
mixing a polymer resin and an antistat agent to form a homogeneous polymer mixture;
introducing the polymer mixture into an extruder;
melting and kneading the polymer mixture in the extruder to form a molten or semi-molten polymer stream;
introducing the polymer stream into a melt pump;
measuring the pressure of the polymer stream exiting the melt pump;
adjusting the pressure of the polymer stream as it exits the melt pump to a predetermined pressure threshold for the polymer stream;
introducing the polymer stream into a pellet die, said pellet die comprising a plurality of fluid channels and corresponding extrusion orifices, the extrusion orifices having diameters ranging from about 0.020 to 0.050 mm;
dividing the polymer stream to flow through the plurality of fluid channels to form a plurality of polymer strands;
extruding the plurality of polymer strands through said extrusion orifices, cutting the plurality of polymer strands to form a plurality of micronized polymer pellets; and
drying and collecting the micronized polymer pellets.

Paragraph 27: The method of Paragraph 26 in which the micronized polymer pellets are characterized by the following:
a) an average particle size of about 450 μm with a standard deviation of less than 25 μm;
b) a surface resistivity ranging from about 1×10⁹ to 1×10¹⁰Ω;
c) a Falling time ranging from about 10 to 12 seconds; and
d) an Angle of Repose ranging from about 30 to 38 degrees.

Paragraph 28: Certain embodiments are in accordance with the method of Paragraph 26 in which the step of adjusting the pressure of the polymer stream comprises measuring a pressure of the polymer stream prior to introducing the polymer stream into the melt pump and then adjusting an operational speed of the melt pump to increase the pressure of the polymer stream to the predetermined pressure threshold.

Paragraph 29: Certain embodiments are in accordance with the method of Paragraph 28 in which the predetermined pressure threshold is stored in a computer having a memory device comprising executable program code, the executable program code being configured to instruct the melt pump to adjust the operational speed of the melt pump to achieve the predetermined pressure threshold for the polymer stream.

Paragraph 30: Certain embodiments are in accordance with the method of one or more of Paragraphs 26 to 29 in which the step of cutting the plurality of polymer strands to form a plurality of micronized polymer pellets is performed within a water bath, the water bath comprising a stream of heated water that is heated to a temperature ranging from about 70 to 90° C.

Paragraph 31: Certain embodiments are in accordance with the method of one or more of Paragraphs 26 to 30 in which the steam of heated water collects the plurality of micronized polymer pellets and carries the plurality of micronized polymer pellets to a dryer unit.

Paragraph 32: Certain embodiments are in accordance with the method of one or more of Paragraphs 26 to 31 in which the polymer resin is selected from the group consisting of polyolefins, nylons, polycarbonates, and polyesters.

Paragraph 33: Certain embodiments are in accordance with the method of one or more of Paragraphs 26 to 32 in which the polymer resin comprises a polyolefin.

Paragraph 34: Certain embodiments are in accordance with the method of Paragraph 33 in which the polyolefin is selected from polyethylene, polypropylene, and blends thereof.

Paragraph 35: Certain embodiments are in accordance with the method of Paragraph 34 in which the polyolefin is selected from the group consisting of linear low density polyethylene (LLDPE), low density polyethylene (LDPE), (mid density polyethylene (MDPE) and high density polyethylene (HDPE), and blends thereof.

Paragraph 36: Certain embodiments are in accordance with the method of Paragraph 35 in which the polymer resin comprises a blend of a LLDPE and a HDPE.

Paragraph 37: Certain embodiments are in accordance with the method of Paragraph 36 in which an amount of LLDPE in the blend is from about 5 to 95 weight percent and the amount of HDPE in the blend is from about 5 to 95 weight percent, based on the total weight of the polymer composition.

Paragraph 38: Certain embodiments are in accordance with the method of one or more of Paragraphs 26 to 37 in which the polymer resin further comprising ethylene vinyl acetate.

Paragraph 39: Certain embodiments are in accordance with the method of one or more of Paragraphs 26 to 38 in which the polymer mixture further comprises a styrene-ethylene-butylene-styrene block copolymer.

Paragraph 40: Certain embodiments are in accordance with the method of one or more of Paragraphs 26 to 39 in which the antistat agent comprises a copolymer of a hydrophobic polymer and a hydrophilic polymer, an ionic liquid, and a salt.

Paragraph 41: Certain embodiments are in accordance with the method of one or more of Paragraphs 26 to 40 in which an amount of antistat agent in the polymer mixture is from about 5 to 35 weight percent, and in particular, from about 10 to 20 weight percent, based on the total weight of the mixture.

Paragraph 42: Certain embodiments are in accordance with the method of one or more of Paragraphs 26 to 41 in which the polymer mixture further comprises one or more of an antioxidant, a styrene containing elastomer, a polyolefin elastomer, and a UV stabilizer.

Paragraph 43: Certain embodiments are in accordance with the method of one or more of Paragraphs 26 to 42 in which the plurality of micronized polymer pellets exhibit an average particle size of less than 500 μm with a standard deviation of less than 50 μm.

Paragraph 44: Certain embodiments are in accordance with the method of one or more of Paragraphs 26 to 43 in which the plurality of micronized polymer pellets are characterized by exhibiting an average particle size ranging from 400 to 500 μm with a standard deviation of less than 50 μm and a surface resistivity ranging from about 1×10⁵ to 1×10¹²Ω.

Paragraph 45: Certain embodiments are in accordance with the method of one or more of Paragraphs 26 to 31 in which the plurality of micronized polymer pellets are characterized by exhibiting a Falling Time ranging from about 10 to 15 seconds and an Angle of Repose ranging from about 30 to 38 degrees.

Paragraph 46: Certain embodiments are in accordance with the method of one or more of Paragraphs 26 to 45 in which the plurality of micronized polymer pellets are characterized by the following:
a) an average particle size ranging from 400 to 500 μm with a standard deviation of less than 50 μm;
b) a surface resistivity ranging from about 1×10⁵ to 1×10¹²Ω;
c) a Falling time ranging from about 10 to 15 seconds; and
d) an Angle of Repose ranging from about 30 to 38 degrees.

Paragraph 47: Certain embodiments are in accordance with the method of one or more of Paragraphs 26 to 46 in which the plurality of micronized polymer pellets are characterized by the following:
a) an average particle size of about 450 μm with a standard deviation of less than 25 μm;
b) a surface resistivity ranging from about 1×10⁹ to 1×10¹⁰Ω;
c) a Falling time ranging from about 10 to 12 seconds; and
d) an Angle of Repose ranging from about 30 to 38 degrees.

Paragraph 48: Certain embodiments are in accordance with the method of one or more of Paragraphs 26 to 47 in which a rotomolded article prepared from the plurality of micronized polymer pellets exhibits an environmental stress crack resistance (ESCR) of at least 500 hours without the observance of cracks or other defects.

Paragraph 49: Certain embodiments are in accordance with the method of one or more of Paragraphs 26 to 47 in which a rotomolded article prepared from the plurality of micronized polymer pellets exhibits an environmental stress crack resistance (ESCR) of at least 1,000 hours, and in particular, at least 2,000 hours, without the observance of cracks or other defects.

Paragraph 50: Certain embodiments are in accordance with the method of Paragraphs 48 or 49 in which the rotomolded article exhibits a surface resistivity ranging from about 1×10⁵ to 1×10¹²Ω.

Paragraph 51: Certain embodiments are in accordance with the method of one or more of Paragraphs 26 to 50 in which the step of adjusting the pressure of the polymer stream comprises increasing the pressure of the polymer stream by a factor at least 2.

Paragraph 52: Certain embodiments are in accordance with the method of one or more of Paragraphs 26 to 50 in which the step of adjusting the pressure of the polymer stream comprises increasing the pressure of the polymer stream by a factor ranging from 2 to 5.

Paragraph 53: Certain aspects of the disclosure are directed to a system for preparing micronized polymer pellets having antistat properties in which the system comprises
a source of a polymer resin and a source of an antistat agent;
an extruder in communication with the source of the polymer resin and the source of the antistat agent, the extruder being configured and arranged to melt knead the polymer resin and antistat agent to form a molten or semi-molten polymer stream;
a melt pump disposed downstream of the extruder and in fluid communication with the extruder, the melt pump having a proximal and distal end, the melt pump being configured to receive the polymer stream from the extruder and adjust a pressure of the polymer stream to a predetermined pressure threshold;
a die disposed downstream of the melt pump, the die comprising a plurality of fluid channels and a plurality of extrusion orifices each associated with a corresponding fluid channel, wherein the die is configured and arrange to distribute the polymer stream into a plurality of polymer strands; and
a pelletizer disposed downstream of the die, the pelletizer configured and arranged to cut the polymer strands to form a plurality of micronized polymer pellets.

Paragraph 54: Certain embodiments are in accordance with the system of Paragraph 53 in which the system comprises a pressure transducer disposed adjacent the distal end of the melt pump, the pressure transducer being configured and arranged to measure a pressure of the polymer stream as it exits the melt pump.

Paragraph 55: Certain embodiments are in accordance with the system of Paragraph 53 in which the system further comprising a computer in communication with the pressure transducer and the melt pump, the computer comprising executable program code for providing instructions to the melt pump to increase or decrease operational speed of the melt pump to adjust the pressure of the polymer melt to the predetermined threshold.

Paragraph 56: Certain embodiments are in accordance with the system of one or more of Paragraphs 53 to 55 in which the system further comprise a water bath and wherein the extrusion orifices of the die are submerged in the water bath.

Paragraph 57: Certain embodiments are in accordance with the system of one or more of Paragraphs 53 to 56 in which the water bath comprises a heated water stream having a temperature from about 70 to 90° C., and wherein said heated water stream is in fluid communication with a dryer unit disposed downstream of the dryer unit, wherein the heated water stream collects the micronized polymer pellets in the water bath and transports them to the dryer unit.

The following examples are provided for illustrating one or more embodiments of the present invention and should not be construed as limiting the invention.

### EXAMPLES

Unless otherwise indicated all percentages are weight percentages. The materials used in the examples are identified below.

LLDPE-1: MHolland, LR 230 U; a linear low density polyethylene.

HDPE-1: LUMICENER, M4041 UV; a metallocene catalyzed high density polyethylene, with a melt flow rate of 4.0 g/10 min (ASTM D1238) and a density of 0.939 g/cc (ASTM D-792), provided by Bay Star Polymers.

HDPE-2: Chevron Phillips, MARLEX® HMN TR-942 (a high density polyethylene having a melt index of 2.0 g/10 min and a density of 0.943 g/cm³ (ASTM D-1505)).

AS-1: Sanyo Chemical Ltd., Pelectron PVL; an antistat agent comprising 1) a copolymer of a hydrophobic polymer and a hydrophilic polymer; 2) an ionic liquid; and 3) a salt.

AS-2: Sanyo Chemical Ltd., PELESTAT 1251; an antistat agent 1) a copolymer of a hydrophobic polymer and a hydrophilic polymer; 2) an ionic liquid; and 3) a salt.

AO-1: BASF, IRGANOX 1010, a sterically hindered primary phenolic used as a primary antioxidant.

AO-2: BASE, IRGAPHOS® 168: a tris(2,4-di-tert.-butylphenyl)phosphite used as a secondary antioxidant

UVS: BASF, TINUVIN®; 571 a liquid benzotriazole UV absorber.

SEBS: Kuraray. SEPTON™ 8006; a styrene-ethylene-butylene-styrene block copolymer.

POE: Exxon Mobil, VISTAMAXX™ 6102, propylene based isotactic alpha-olefin copolymer having an MFR of 1.4 g/10 min (ASTM D1238), an ethylene content of about 16 weight percent, and a density of 0.862 g/cm³ (ASTM D-792).

### Test Methods

Aerated Bulk Density was measured in accordance with ASTM D1895 Method 1.

Particle Size was measured in accordance with ASTM E3340-22 measured with Microtrac 3500.

Electric Surface Resistivity was measured in accordance with ASTM D257.

Particle Fall Rate was evaluated in accordance with the Test Method for Flowability (Dry Flow Rate) and Apparent Density (Bulk Density) of Polyethylene Powders set forth by the Association of Rotational Molders (Version 2.1 (November 2011).

Angle of Repose was measured in accordance with ASTM D6393-08.

Environmental Stress Cracking Resistance was measured in accordance with ASTM D1693, method B.

Procedure for preparing the micronized polymer pellets.

In Examples 1 to 6, the components of the polymer composition were fed into a high intensity mixer and mixed to form a homogeneous polymeric blend. This material was then introduced into a volumetric feeder and then metered into a twin extruder. In the extruder, the components were heated, melted and kneaded at a temperature from 190 to 200° C. to form a molten or semi-molten polymer stream. The polymer stream was fed into a melt pump (HGP-110/70 available from PSI). A first pressure transducer (available from Gefran) was disposed at the inlet of the melt pump and measured the inlet pressure of the polymer stream as it entered the melt pump, and a second pressure transducer (also available from Gefran) was disposed at the outlet of the melt pump to measure the outlet pressure of the polymer stream as it exited the melt pump. The first and second pressure transducers were in communication with a Programmable Logic Controller (PLC) programmed to maintain the operation of the melt pump at a desired outlet pressure. In the examples, the outlet pressure of polymer stream was maintained at a pressure of approximately 2,200 psi. The polymer stream was then introduced into a micropelletizing die having 2240 discrete extrusion orifices. Each extrusion orifice had a diameter of 0.036 mm to form a plurality of polymeric strands. The pelletizing die was maintained at a temperature of approximately 320° C. The polymeric strands were extruded from the extrusion orifices directly into a bath comprising a heated stream of water. The polymeric strands were cut with a pelletizer (available from Gala) to obtain electrically conductive resin micropellets. The stream of heated water was heated to a temperature of 82° C. and was introduced into the bath at a rate of 60 gallons per minute. Thereafter, the stream of heated water carried the micronized polymer pellets to a centrifugal dryer at which point the pellets were dried, clarified, and collected.

### Example 1

In Example 1, a bulk composition comprising a plurality of micronized polymer pellets was prepared using the process described above. The micronized polymer pellets comprised a polymeric blend of 84.63 weight percent of HDPE-1, 15.0 weight percent AS-1, 0.05 weight percent AO-1, 0.02 weight percent AO-2, and 0.30 weight percent UVS, based on the total weight of the polymer composition. The resulting polymer composition was evaluated for flow properties and average particle size. The results are summarized in Table 1, below.

### Example 2

In Example 2, a bulk composition comprising a plurality of micronized polymer pellets was prepared using the process described above. The micronized polymer pellets comprised a polymeric blend of 84.63 weight percent of HDPE-1, 15.0 weight percent AS-1, 0.05 weight percent AO-1, 0.02 weight percent AO-2, and 0.30 weight percent UVS, based on the total weight of the polymer composition. The resulting polymer composition was evaluated for flow properties and average particle size. The results are summarized in Table 1, below.

### Example 3

In Example 3, a bulk composition comprising a plurality of micronized polymer pellets was prepared using the process described above. The micronized polymer pellets comprised a polymeric blend of 7.96 weight percent LLDPE-1, 71.63 weight percent of HDPE-1, 15.0 weight percent AS-1, 5.04 weight percent SEBS, 0.05 weight percent AO-1, 0.02 weight percent AO-2, and 0.30 weight percent UVS, based on the total weight of the polymer composition. The resulting polymer composition was evaluated for flow properties and average particle size. The results are summarized in Table 1, below.

### Example 4

In Example 4, a bulk composition comprising a plurality of micronized polymer pellets was prepared using the process described above. The micronized polymer pellets comprised a polymeric blend of 79.59 weight percent LLDPE-1, 15.0 weight percent AS-1, 5.04 weight percent SEBS, 0.05 weight percent AO-1, 0.02 weight percent AO-2, and 0.30 weight percent UVS, based on the total weight of the polymer composition. The resulting polymer composition was evaluated for flow properties and average particle size. The results are summarized in Table 1, below.

### Example 5

In Example 5, a bulk composition comprising a plurality of micronized polymer pellets was prepared using the process described above. The micronized polymer pellets comprised a polymeric blend of 79.59 weight percent LLDPE-1, 15.0 weight percent AS-1, 5.04 weight percent SEBS, 0.05 weight percent AO-1, 0.02 weight percent AO-2, and 0.30 weight percent UVS, based on the total weight of the polymer composition. The resulting polymer composition was evaluated for flow properties and average particle size. The results are summarized in Table 1, below.

TABLE 1
Properties of Micronized Polymer Pellets of Examples 1-5

| | Average | Falling | Angle of | Aerated bulk |
|---|---|---|---|---|
| | Particle | Time | Repose | density |
| Example No. | Size (μm) | (sec.) | (°) | (g/cm³) |
| Example 1 | 540 | 12.3 | 32.8 | 0.478 |
| Example 2 | 517 | 11.3 | 34.7 | 0.489 |
| Example 3 | 514 | 11.6 | 36.4 | 0.478 |
| Example 4 | 514 | 11.3 | 35.9 | 0.493 |
| Example 5 | 519 | 11.1 | 36.3 | 0.495 |

### Example 6

In Example 6, a bulk composition comprising a plurality of micronized polymer pellets was prepared using the process described above. The micronized polymer pellets comprised a polymeric blend of 84.50 weight percent LLDPE-1, 15.0 weight percent AS-1, 0.15 weight percent AO-1, 0.05 weight percent AO-2, and 0.30 weight percent UVS, based on the total weight of the polymer composition. The resulting polymer composition was evaluated for surface resistivity and environmental stress cracking resistance (ESCR).

The micronized polymer pellets of Example 6 exhibited an inner surface resistivity of 3.9×10¹⁰Ω, and an outer surface resistivity of 3.0×10¹⁰Ω.

The ESCR assessment was performed by an independent lab: the Plastics Innovation & Resource Center of the Pennsylvania College of Technology (PCT). A compression molded article was prepared at the facilities of the PCT. Following 2,000 hours of observation, no cracks or other defects in the rotomolded part were observed.

### Example 7

A further example was prepared with the process described above. The polymer composition comprised a blend of 77.3 weight percent HDPE-2, 15.0 weight percent AS-1, 7.2 weight percent of 0.3 weight percent AO-1, 0.1 weight percent AO-2, and 0.1 weight percent UVS, based on the total weight of the polymer composition. The polymer composition was used to prepare a bulk composition comprising a plurality of micronized polymer pellets, which were then used to make a compression molded article. Following 2,000 hours of observation, no cracks or other defects in the rotomolded part were observed.

Modifications of the inventions set forth herein will come to mind to one skilled in the art to which the inventions pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A bulk polymer composition having a plurality of micronized polymer pellets comprising a blend of a polymer resin and an antistatic agent, the plurality of polymer particles having an average particle size of less than 800 microns (μm), and wherein the polymer composition exhibits a surface resistivity of less than 1×10¹³Ω.

2. The bulk polymer composition according to claim 1, wherein the polymer resin is selected from the group consisting of polyolefins, nylons, polycarbonates, and polyesters.

3. The bulk polymer composition according to claim 1, wherein the polymer comprises a polyolefin selected from polyethylene, polypropylene, and blends thereof.

4. The bulk polymer composition according to claim 3, wherein the polyolefin is selected from the group consisting of linear low density polyethylene (LLDPE), low density polyethylene (LDPE), (mid density polyethylene (MDPE) and high density polyethylene (HDPE), and blends thereof.

5. The bulk polymer composition according to claim 1, wherein the polymer resin comprises a blend of a LLDPE and a HDPE, and wherein the amount of LLDPE in the blend is from about 5 to 95 weight percent and the amount of HDPE in the blend is from about 5 to 95 weight percent, based on the total weight of the polymer composition.

6. The bulk polymer composition according to claim 1, further comprising ethylene vinyl acetate.

7. The bulk polymer composition according to claim 1, further comprising a propylene based α-olefin copolymer, styrene-ethylene-butylene-styrene block copolymer, or a blend thereof.

8. The bulk polymer composition according to claim 1, wherein the antistat agent comprises a copolymer of a hydrophobic polymer and a hydrophilic polymer, an ionic liquid, and a salt.

9. The bulk polymer composition according to claim 8, wherein the amount of antistat agent in the polymer composition is from about 5 to 35 weight percent, and in particular, from about 10 to 20 weight percent, based on the total weight of the composition.

10. The bulk polymer composition according to claim 1, wherein the plurality of micronized polymer pellets exhibit an average particle size of less than 500 μm with a standard deviation of less than 50 μm.

11. The bulk polymer composition according to claim 1, wherein the plurality of micronized polymer pellets are characterized by exhibiting an average particle size ranging from 400 to 500 μm with a standard deviation of less than 50 μm and a surface resistivity ranging from about 1×10⁵ to 1×10¹²Ω.

12. The bulk polymer composition according to claim 1, wherein the plurality of micronized polymer pellets are characterized by exhibiting a Falling Time ranging from about 10 to 15 seconds and an Angle of Repose ranging from about 30 to 38 degrees.

13. The bulk polymer composition according to claim 1, wherein the plurality of micronized polymer pellets are characterized by the following:
a) an average particle size ranging from 400 to 500 μm with a standard deviation of less than 50 μm;
b) a surface resistivity ranging from about 1×10⁵ to 1×10¹²Ω;
c) a Falling time ranging from about 10 to 15 seconds; and
d) an Angle of Repose ranging from about 30 to 38 degrees.

14. The bulk polymer composition according to claim 1, wherein the plurality of micronized polymer pellets are characterized by the following:
a) an average particle size of about 450 μm with a standard deviation of less than 25 μm;
b) a surface resistivity ranging from about 1×10⁹ to 1×10¹⁰Ω;
c) a Falling time ranging from about 10 to 12 seconds; and
d) an Angle of Repose ranging from about 30 to 38 degrees.

15. The bulk polymer composition according to claim 1, wherein in a rotomolded article prepared from the plurality of micronized polymer pellets exhibits an environmental stress crack resistance (ESCR) of one or more of the following, at least 500 hours, at least 1,000 hours, and at least 2,000 without the observance of cracks or other defects.

16. The bulk polymer composition according to claim 15, wherein the rotomolded article exhibits a surface resistivity ranging from about 1×10⁵ to 1×10¹²Ω.

17. The bulk polymer composition according to claim 1, wherein the composition comprises:
from about 70 to 85 weight percent of a polyolefin resin (e.g., polyethylene);
from about 5 to 20 weight percent of the antistat agent, and
from about 5 to 15 weight percent of a polyolefin elastomer, based on the total weight of the polymer composition.

18. The bulk polymer composition according to claim 1, wherein the polyolefin resin comprises a high density polyethylene, the antistat agent comprises a copolymer of a hydrophobic polymer and a hydrophilic polymer, an ionic liquid, and a salt, and the polyolefin elastomer comprises a propylene based alpha-olefin copolymer.

19. The bulk polymer composition according to claim 17, wherein the polyolefin resin is present in an amount from about 75 to 80 weight percent, the antistat agent is present in an amount from about 12 to 18 weight percent, and the polyolefin elastomer is present in an amount from about 6 to 10 weight percent, based on the total weight of the polymer composition.

20. The bulk polymer composition according to claim 17, wherein the plurality of micronized polymer pellets are characterized by the following:
a) an average particle size ranging from 400 to 500 μm with a standard deviation of less than 50 μm;
b) a surface resistivity ranging from about 1×10⁵ to 1×10¹²Ω;
c) a Falling time ranging from about 10 to 15 seconds; and
d) an Angle of Repose ranging from about 30 to 38 degrees.

21. A method of preparing a micronized polymer pellets comprising the steps of:
mixing a polymer resin and an antistat agent to form a homogeneous polymer mixture;
introducing the polymer mixture into an extruder;
melting and kneading the polymer mixture in the extruder to form a molten or semi-molten polymer stream;
introducing the polymer stream into a melt pump;
measuring the pressure of the polymer stream exiting the melt pump;
adjusting the pressure of the polymer stream as it exits the melt pump to a predetermined pressure threshold for the polymer stream;
introducing the polymer stream into a pellet die, said pellet die comprising a plurality of fluid channels and corresponding extrusion orifices, the extrusion orifices having diameters ranging from about 0.020 to 0.050 mm;
dividing the polymer stream to flow through the plurality of fluid channels to form a plurality of polymer strands;
extruding the plurality of polymer strands through said extrusion orifices, cutting the plurality of polymer strands to form a plurality of micronized polymer pellets; and
drying and collecting the micronized polymer pellets.

22. A system for preparing micronized polymer pellets having antistat properties, the system comprising
a source of a polymer resin and a source of an antistat agent;
an extruder in communication with the source of the polymer resin and the source of the antistat agent, the extruder being configured and arranged to melt knead the polymer resin and antistat agent to form a molten or semi-molten polymer stream;
a melt pump disposed downstream of the extruder and in fluid communication with the extruder, the melt pump having a proximal and distal end, the melt pump being configured to receive the polymer stream from the extruder and adjust a pressure of the polymer stream to a predetermined pressure threshold;
a die disposed downstream of the melt pump, the die comprising a plurality of fluid channels and a plurality of extrusion orifices each associated with a corresponding fluid channel, wherein the die is configured and arranged to distribute the polymer stream into a plurality of polymer strands; and
a pelletizer disposed downstream of the die, the pelletizer configured and arranged to cut the polymer strands to form a plurality of micronized polymer pellets.
